(19) United States
(12) Patent Application Publication
(10) Pub. No.: US 2025/0111663 A1
(43) Pub. Date: Apr. 3, 2025

(54) DISPLAYING FULLY CONNECTED LAYERS IN A NEURAL NETWORK AS SEISMIC DATA

(71) Applicant: Schlumberger Technology Corporation, Sugar Land, TX (US)

(72) Inventors: Amir Shamsa, Calgary (CA); Maria Perezhogina, Houston, TX (US); Mehdi Paydayesh, Crawley (GB)

(21) Appl. No.: 18/902,273

(22) Filed: Sep. 30, 2024

Related U.S. Application Data
(60) Provisional application No. 63/586,675, filed on Sep. 29, 2023.

(51) Int. Cl. G06V 10/82; E21B 44/00; E21B 49/00; G06V 20/10

(52) U.S. Cl. CPC G06V 10/82; E21B 44/00; E21B 49/00; G06V 20/10; E21B 2200/22

(57) ABSTRACT

A method for improving an interpretability of a neural network includes receiving a plurality of images. The plurality of images are received by the neural network that includes a plurality of layers. The method also includes selecting one of the layers from the plurality of layers in the neural network. The method also includes determining a long vector corresponding to each of the images of the plurality of images to produce a plurality of long vectors. The plurality of long vectors are each determined from the selected layer. The method also includes combining the plurality of long vectors into a matrix. The method also includes converting the matrix into a plurality of seismic traces.

### CROSS REFERENCE TO RELATED APPLICATION

This application claims priority to U.S. Provisional Patent Application No. 63/586,675, filed on Sep. 29, 2023, which is incorporated by reference in its entirety.

### BACKGROUND

The interpretability of a neural network refers to the extent to which a human can understand the decision-making process of the model. Given the often complex and non-linear transformations these models apply to their inputs, they are usually referred to as “black box” models, known for their high performance but lacking in transparency. The lack of interpretability can pose problems, particularly when used in sensitive domains such as healthcare, law, and/or energy where it is important to understand how and why a decision was made.

### SUMMARY

A method for improving an interpretability of a neural network is disclosed. The method includes receiving a plurality of images. The plurality of images are received by the neural network that includes a plurality of layers. The method also includes selecting one of the layers from the plurality of layers in the neural network. The method also includes determining a long vector corresponding to each of the images of the plurality of images to produce a plurality of long vectors. The plurality of long vectors are each determined from the selected layer. The method also includes combining the plurality of long vectors into a matrix. The method also includes converting the matrix into a plurality of seismic traces.

A computing system is also disclosed. The computing system includes one or more processors and a memory system. The memory system includes one or more non-transitory computer-readable media storing instructions that, when executed by at least one of the one or more processors, cause the computing system to perform operations. The operations include receiving a plurality of images. The plurality of images include core images of a subsurface formation. The plurality of images are received by a neural network that includes a plurality of layers. The operations also include selecting one of the layers from the plurality of layers in the neural network. The selected layer includes a predetermined number of nodes. The operations also include determining a long vector corresponding to each of the plurality of images to produce a plurality of long vectors. The plurality of long vectors are each determined from the selected layer. The plurality of long vectors are determined by extracting neural responses to predetermined features in the images. The plurality of long vectors capture the neural responses as a linear representation of the predetermined features. The operations also include combining the plurality of long vectors into a matrix. The matrix is a 2D matrix. The matrix includes a plurality of columns. The operations also include converting each of the columns into a seismic trace to produce a plurality of seismic traces. Each of the columns is converted by mapping variations in an intensity of the predetermined features along a spatial dimension of the images. The intensity includes a value of a number in the long vectors or the matrix. The seismic traces reveal hidden patterns or relationships within the images, making the neural responses interpretable in a known geoscience context. The operations also include displaying the seismic traces. The seismic traces are displayed collectively as a seismic section.

A non-transitory computer-readable medium is also disclosed. The medium stores instructions that, when executed by one or more processors of a computing system, cause the computing system to perform operations. The operations include receiving a plurality of images. The plurality of images include core images of a subsurface formation. The plurality of images are received by a neural network that includes a plurality of layers. The operations also include selecting one of the layers from the plurality of layers in the neural network. The selected layer includes a predetermined number of nodes. The operations also include determining a long vector corresponding to each of the images of the plurality of images to produce a plurality of long vectors. The plurality of long vectors are each determined from the selected layer. The plurality of long vectors are determined by extracting neural responses to predetermined features in the plurality of images. The plurality of long vectors capture the neural responses as a linear representation of the predetermined features. The predetermined features include an edge, a color, or a hole that is circular or planar. The operations also include combining the plurality of long vectors into a matrix. The matrix is a 2D matrix. The matrix includes a plurality of columns. Each column of the plurality of columns includes a unique set of the predetermined features. The operations also include converting each column of the plurality of columns into a seismic trace to produce a plurality of seismic traces. Each column of the plurality of columns is converted by mapping variations in an intensity of the predetermined features along a spatial dimension of the plurality of images. The intensity includes a value of a number in the long vector or the matrix. Each column of the plurality of columns is converted by transforming data from the plurality of long vectors into a data format analogous to seismic data. The seismic traces reveal hidden patterns or relationships within the plurality of images, making the neural responses interpretable in a known geoscience context. The hidden patterns and relationships include a shape in the plurality of images that is associated with a predetermined pattern or color. The operations also include displaying the seismic traces. The seismic traces are displayed collectively as a seismic section.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIGS. 1A, 1B, 1C, 1D, 2, 3A, and 3B illustrate simplified, schematic views of an oilfield and its operation, according to an embodiment.

FIG. 4 illustrates a section (e.g., slice) of seismic data, according to an embodiment.

FIG. 5 illustrates a neural network with one or more (e.g., two) hidden layers, according to an embodiment.

FIGS. 6A and 6B illustrate representations of a hidden layer for a plurality of (e.g., fifty) different images, according to an embedment.

FIG. 7A illustrates a matrix, and FIG. 7B illustrates a trace that is a visual representation of the matrix, according to an embodiment.

FIG. 8 illustrates a flowchart of a method for improving an interpretability of a neural network, according to an embodiment.

FIG. 9 illustrates a schematic view of the method for improving the interpretability of the neural network, according to an embodiment.

FIG. 10 illustrates a schematic view of a computing system for performing at least a portion of the method(s) described herein, according to an embodiment.

### DETAILED DESCRIPTION

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object could be termed a second object, and, similarly, a second object could be termed a first object, without departing from the scope of the invention. The first object and the second object are both objects, respectively, but they are not to be considered the same object.

The terminology used in the description of the invention herein is for the purpose of describing particular embodiments only and is not intended to be limiting of the invention. As used in the description of the invention and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques and workflows that are in accordance with some embodiments. Some operations in the processing procedures, methods, techniques and workflows disclosed herein may be combined and/or the order of some operations may be changed.

### Oilfield

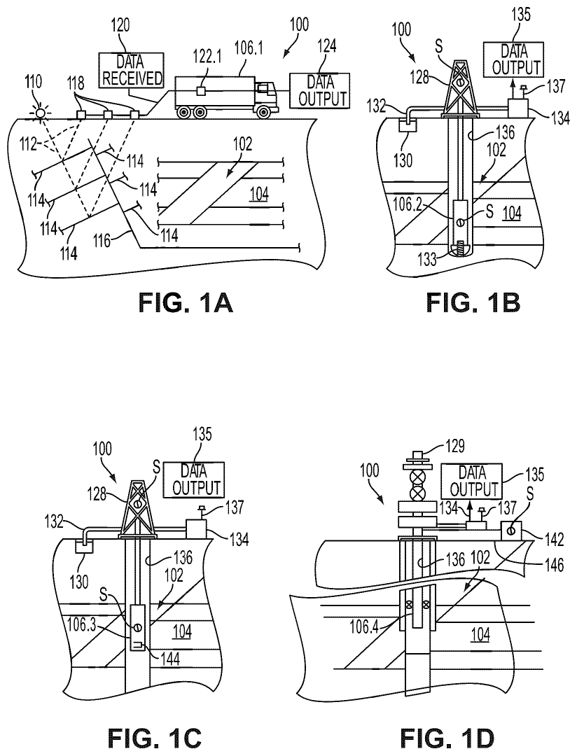

FIGS. 1A-1D illustrate simplified, schematic views of oilfield 100 having subterranean formation 102 containing reservoir 104 therein in accordance with implementations of various technologies and techniques described herein. Although embodiments of the present method are at least partially described herein with reference to an oilfield, it will be appreciated that this is merely an illustrative example. Embodiments of the present method may be employed in any application in which visualizing, modeling, or otherwise identifying subsurface features (e.g., geological features) may be useful. Examples outside of the oilfield context include subsurface mapping for wind arrays and/or solar arrays, geothermal energy production, mining operations, offshore/deep ocean applications, etc.

FIG. 1A illustrates a survey operation being performed by a survey tool, such as seismic truck 106.1, to measure properties of the subterranean formation. The survey operation is a seismic survey operation for producing sound vibrations. In FIG. 1A, one such sound vibration, e.g., sound vibration 112 generated by source 110, reflects off horizons 114 in earth formation 116. A set of sound vibrations is received by sensors, such as geophone-receivers 118, situated on the earth's surface. The data received 120 is provided as input data to a computer 122.1 of a seismic truck 106.1, and responsive to the input data, computer 122.1 generates seismic data output 124. This seismic data output may be stored, transmitted or further processed as desired, for example, by data reduction.

FIG. 1B illustrates a drilling operation being performed by drilling tools 106.2 suspended by rig 128 and advanced into subterranean formations 102 to form wellbore 136. Mud pit 130 is used to draw drilling mud into the drilling tools via flow line 132 for circulating drilling mud down through the drilling tools, then up wellbore 136 and back to the surface. The drilling mud is typically filtered and returned to the mud pit. A circulating system may be used for storing, controlling, or filtering the flowing drilling mud. The drilling tools are advanced into subterranean formations 102 to reach reservoir 104. Each well may target one or more reservoirs. The drilling tools are adapted for measuring downhole properties using logging while drilling tools. The logging while drilling tools may also be adapted for taking core sample 133 as shown.

Computer facilities may be positioned at various locations about the oilfield 100 (e.g., the surface unit 134) and/or at remote locations. Surface unit 134 may be used to communicate with the drilling tools and/or offsite operations, as well as with other surface or downhole sensors. Surface unit 134 is capable of communicating with the drilling tools to send commands to the drilling tools, and to receive data therefrom. Surface unit 134 may also collect data generated during the drilling operation and produce data output 135, which may then be stored or transmitted.

Sensors (S), such as gauges, may be positioned about oilfield 100 to collect data relating to various oilfield operations as described previously. As shown, sensor (S) is positioned in one or more locations in the drilling tools and/or at rig 128 to measure drilling parameters, such as weight on bit, torque on bit, pressures, temperatures, flow rates, compositions, rotary speed, and/or other parameters of the field operation. Sensors (S) may also be positioned in one or more locations in the circulating system.

Drilling tools 106.2 may include a bottom hole assembly (BHA) (not shown), generally referenced, near the drill bit (e.g., within several drill collar lengths from the drill bit). The bottom hole assembly includes capabilities for measuring, processing, and storing information, as well as communicating with surface unit 134. The bottom hole assembly further includes drill collars for performing various other measurement functions.

The bottom hole assembly may include a communication subassembly that communicates with surface unit 134. The communication subassembly is adapted to send signals to and receive signals from the surface using a communications channel such as mud pulse telemetry, electro-magnetic telemetry, or wired drill pipe communications. The communication subassembly may include, for example, a transmitter that generates a signal, such as an acoustic or electromagnetic signal, which is representative of the measured drilling parameters. It will be appreciated by one of skill in the art that a variety of telemetry systems may be employed, such as wired drill pipe, electromagnetic or other known telemetry systems.

Typically, the wellbore is drilled according to a drilling plan that is established prior to drilling. The drilling plan typically sets forth equipment, pressures, trajectories and/or other parameters that define the drilling process for the wellsite. The drilling operation may then be performed according to the drilling plan. However, as information is gathered, the drilling operation may need to deviate from the drilling plan. Additionally, as drilling or other operations are performed, the subsurface conditions may change. The earth model may also need adjustment as new information is collected

The data gathered by sensors (S) may be collected by surface unit 134 and/or other data collection sources for analysis or other processing. The data collected by sensors (S) may be used alone or in combination with other data. The data may be collected in one or more databases and/or transmitted on or offsite. The data may be historical data, real time data, or combinations thereof. The real time data may be used in real time, or stored for later use. The data may also be combined with historical data or other inputs for further analysis. The data may be stored in separate databases, or combined into a single database.

Surface unit 134 may include transceiver 137 to allow communications between surface unit 134 and various portions of the oilfield 100 or other locations. Surface unit 134 may also be provided with or functionally connected to one or more controllers (not shown) for actuating mechanisms at oilfield 100. Surface unit 134 may then send command signals to oilfield 100 in response to data received. Surface unit 134 may receive commands via transceiver 137 or may itself execute commands to the controller. A processor may be provided to analyze the data (locally or remotely), make the decisions and/or actuate the controller. In this manner, oilfield 100 may be selectively adjusted based on the data collected. This technique may be used to optimize (or improve) portions of the field operation, such as controlling drilling, weight on bit, pump rates, or other parameters. These adjustments may be made automatically based on computer protocol, and/or manually by an operator. In some cases, well plans may be adjusted to select optimum (or improved) operating conditions, or to avoid problems.

FIG. 1C illustrates a wireline operation being performed by wireline tool 106.3 suspended by rig 128 and into wellbore 136 of FIG. 1B. Wireline tool 106.3 is adapted for deployment into wellbore 136 for generating well logs, performing downhole tests and/or collecting samples. Wireline tool 106.3 may be used to provide another method and apparatus for performing a seismic survey operation. Wireline tool 106.3 may, for example, have an explosive, radioactive, electrical, or acoustic energy source 144 that sends and/or receives electrical signals to surrounding subterranean formations 102 and fluids therein.

Wireline tool 106.3 may be operatively connected to, for example, geophones 118 and a computer 122.1 of a seismic truck 106.1 of FIG. 1A. Wireline tool 106.3 may also provide data to surface unit 134. Surface unit 134 may collect data generated during the wireline operation and may produce data output 135 that may be stored or transmitted. Wireline tool 106.3 may be positioned at various depths in the wellbore 136 to provide a survey or other information relating to the subterranean formation 102.

Sensors (S), such as gauges, may be positioned about oilfield 100 to collect data relating to various field operations as described previously. As shown, sensor S is positioned in wireline tool 106.3 to measure downhole parameters which relate to, for example porosity, permeability, fluid composition and/or other parameters of the field operation.

FIG. 1D illustrates a production operation being performed by production tool 106.4 deployed from a production unit or Christmas tree 129 and into completed wellbore 136 for drawing fluid from the downhole reservoirs into surface facilities 142. The fluid flows from reservoir 104 through perforations in the casing (not shown) and into production tool 106.4 in wellbore 136 and to surface facilities 142 via gathering network 146.

Sensors (S), such as gauges, may be positioned about oilfield 100 to collect data relating to various field operations as described previously. As shown, the sensor (S) may be positioned in production tool 106.4 or associated equipment, such as Christmas tree 129, gathering network 146, surface facility 142, and/or the production facility, to measure fluid parameters, such as fluid composition, flow rates, pressures, temperatures, and/or other parameters of the production operation.

Production may also include injection wells for added recovery. One or more gathering facilities may be operatively connected to one or more of the wellsites for selectively collecting downhole fluids from the wellsite(s).

While FIGS. 1B-1D illustrate tools used to measure properties of an oilfield, it will be appreciated that the tools may be used in connection with non-oilfield operations, such as gas fields, mines, aquifers, storage or other subterranean facilities. Also, while certain data acquisition tools are depicted, it will be appreciated that various measurement tools capable of sensing parameters, such as seismic two-way travel time, density, resistivity, production rate, etc., of the subterranean formation and/or its geological formations may be used. Various sensors (S) may be located at various positions along the wellbore and/or the monitoring tools to collect and/or monitor the desired data. Other sources of data may also be provided from offsite locations.

The field configurations of FIGS. 1A-1D are intended to provide a brief description of an example of a field usable with oilfield application frameworks. Part of, or the entirety, of oilfield 100 may be on land, water and/or sea. Also, while a single field measured at a single location is depicted, oilfield applications may be utilized with any combination of one or more oilfields, one or more processing facilities and one or more wellsites.

### Data Acquisition Tools

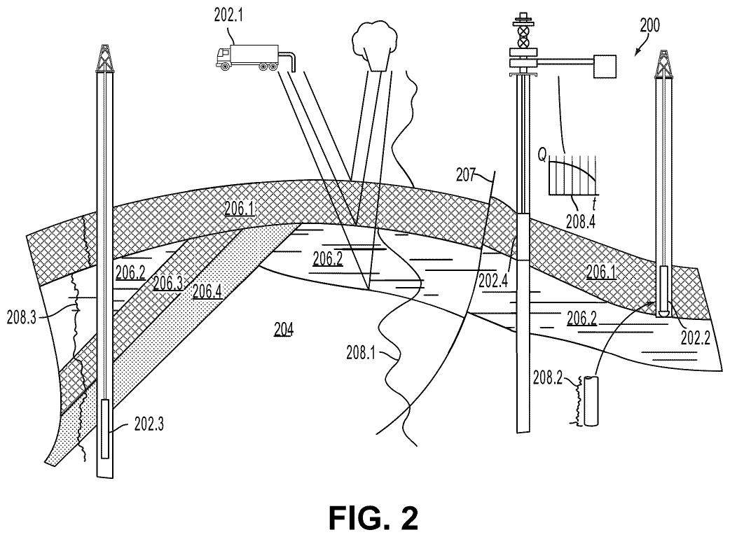

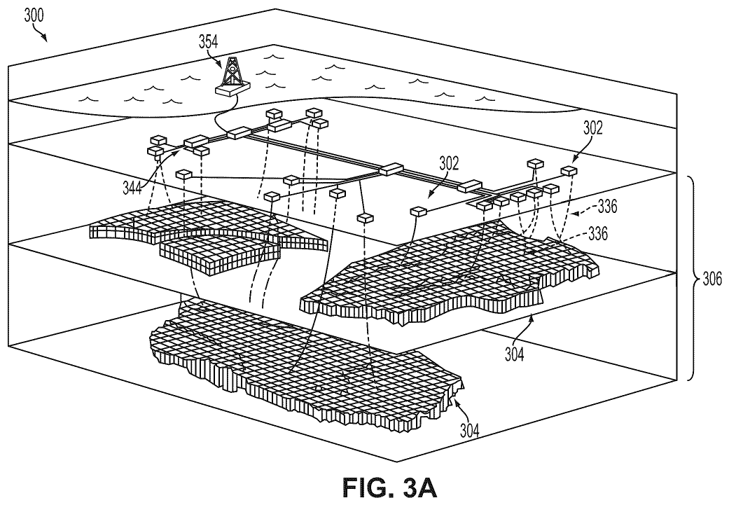

FIG. 2 illustrates a schematic view, partially in cross section of oilfield 200 having data acquisition tools 202.1, 202.2, 202.3 and 202.4 positioned at various locations along oilfield 200 for collecting data of subterranean formation 204 in accordance with implementations of various technologies and techniques described herein. Data acquisition tools 202.1-202.4 may be the same as data acquisition tools 106.1-106.4 of FIGS. 1A-1D, respectively, or others not depicted. As shown, data acquisition tools 202.1-202.4 generate data plots or measurements 208.1-208.4, respectively. These data plots are depicted along oilfield 200 to demonstrate the data generated by the various operations.

Data plots 208.1-208.3 are examples of static data plots that may be generated by data acquisition tools 202.1-202.3, respectively; however, it should be understood that data plots 208.1-208.3 may also be data plots that are updated in real time. These measurements may be analyzed to better define the properties of the formation(s) and/or determine the accuracy of the measurements and/or for checking for errors. The plots of each of the respective measurements may be aligned and scaled for comparison and verification of the properties.

Static data plot 208.1 is a seismic two-way response over a period of time. Static plot 208.2 is core sample data measured from a core sample of the formation 204. The core sample may be used to provide data, such as a graph of the density, porosity, permeability, or some other physical property of the core sample over the length of the core. Tests for density and viscosity may be performed on the fluids in the core at varying pressures and temperatures. Static data plot 208.3 is a logging trace that typically provides a resistivity or other measurement of the formation at various depths.

A production decline curve or graph 208.4 is a dynamic data plot of the fluid flow rate over time. The production decline curve typically provides the production rate as a function of time. As the fluid flows through the wellbore, measurements are taken of fluid properties, such as flow rates, pressures, composition, etc.

Other data may also be collected, such as historical data, user inputs, economic information, and/or other measurement data and other parameters of interest. As described below, the static and dynamic measurements may be analyzed and used to generate models of the subterranean formation to determine characteristics thereof. Similar measurements may also be used to measure changes in formation aspects over time.

The subterranean structure 204 has a plurality of geological formations 206.1-206.4. As shown, this structure has several formations or layers, including a shale layer 206.1, a carbonate layer 206.2, a shale layer 206.3 and a sand layer 206.4. A fault 207 extends through the shale layer 206.1 and the carbonate layer 206.2. The static data acquisition tools are adapted to take measurements and detect characteristics of the formations.

While a specific subterranean formation with specific geological structures is depicted, it will be appreciated that oilfield 200 may contain a variety of geological structures and/or formations, sometimes having extreme complexity. In some locations, typically below the water line, fluid may occupy pore spaces of the formations. Each of the measurement devices may be used to measure properties of the formations and/or its geological features. While each acquisition tool is shown as being in specific locations in oilfield 200, it will be appreciated that one or more types of measurement may be taken at one or more locations across one or more fields or other locations for comparison and/or analysis.

The data collected from various sources, such as the data acquisition tools of FIG. 2, may then be processed and/or evaluated. Typically, seismic data displayed in static data plot 208.1 from data acquisition tool 202.1 is used by a geophysicist to determine characteristics of the subterranean formations and features. The core data shown in static plot 208.2 and/or log data from well log 208.3 are typically used by a geologist to determine various characteristics of the subterranean formation. The production data from graph 208.4 is typically used by the reservoir engineer to determine fluid flow reservoir characteristics. The data analyzed by the geologist, geophysicist and the reservoir engineer may be analyzed using modeling techniques.

### Production Operations

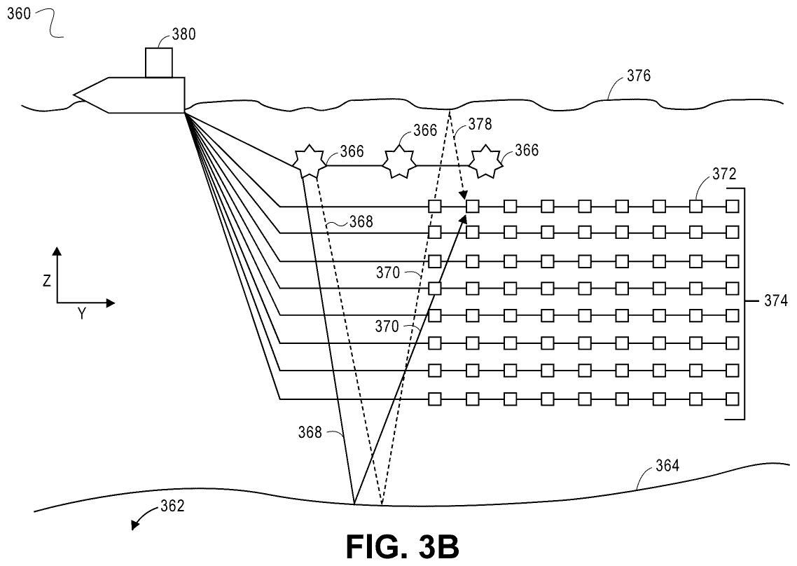

FIG. 3A illustrates an oilfield 300 for performing production operations in accordance with implementations of various technologies and techniques described herein. As shown, the oilfield has a plurality of wellsites 302 operatively connected to central processing facility 354. The oilfield configuration of FIG. 3A is not intended to limit the scope of the oilfield application system. Part, or all, of the oilfield may be on land and/or sea. Also, while a single oilfield with a single processing facility and a plurality of wellsites is depicted, any combination of one or more oilfields, one or more processing facilities and one or more wellsites may be present.

Each wellsite 302 has equipment that forms wellbore 336 into the earth. The wellbores extend through subterranean formations 306 including reservoirs 304. These reservoirs 304 contain fluids, such as hydrocarbons. The wellsites draw fluid from the reservoirs and pass them to the processing facilities via surface networks 344. The surface networks 344 have tubing and control mechanisms for controlling the flow of fluids from the wellsite to processing facility 354.

Attention is now directed to FIG. 3B, which illustrates a side view of a marine-based survey 360 of a subterranean subsurface 362 in accordance with one or more implementations of various techniques described herein. Subsurface 362 includes seafloor surface 364. Seismic sources 366 may include marine sources such as vibroseis or airguns, which may propagate seismic waves 368 (e.g., energy signals) into the Earth over an extended period of time or at a nearly instantaneous energy provided by impulsive sources. The seismic waves may be propagated by marine sources as a frequency sweep signal. For example, marine sources of the vibroseis type may initially emit a seismic wave at a low frequency (e.g., 5 Hz) and increase the seismic wave to a high frequency (e.g., 80-90 Hz) over time.

The component(s) of the seismic waves 368 may be reflected and converted by seafloor surface 364 (i.e., reflector), and seismic wave reflections 370 may be received by a plurality of seismic receivers 372. Seismic receivers 372 may be disposed on a plurality of streamers (i.e., streamer array 374). The seismic receivers 372 may generate electrical signals representative of the received seismic wave reflections 370. The electrical signals may be embedded with information regarding the subsurface 362 and captured as a record of seismic data.

In one implementation, each streamer may include streamer steering devices such as a bird, a deflector, a tail buoy and the like, which are not illustrated in this application. The streamer steering devices may be used to control the position of the streamers in accordance with the techniques described herein.

In one implementation, seismic wave reflections 370 may travel upward and reach the water/air interface at the water surface 376, a portion of reflections 370 may then reflect downward again (i.e., sea-surface ghost waves 378) and be received by the plurality of seismic receivers 372. The sea-surface ghost waves 378 may be referred to as surface multiples. The point on the water surface 376 at which the wave is reflected downward is generally referred to as the downward reflection point.

The electrical signals may be transmitted to a vessel 380 via transmission cables, wireless communication or the like. The vessel 380 may then transmit the electrical signals to a data processing center. Alternatively, the vessel 380 may include an onboard computer capable of processing the electrical signals (i.e., seismic data). Those skilled in the art having the benefit of this disclosure will appreciate that this illustration is highly idealized. For instance, surveys may be of formations deep beneath the surface. The formations may typically include multiple reflectors, some of which may include dipping events, and may generate multiple reflections (including wave conversion) for receipt by the seismic receivers 372. In one implementation, the seismic data may be processed to generate a seismic image of the subsurface 362.

Marine seismic acquisition systems tow each streamer in streamer array 374 at the same depth (e.g., 5-10 m). However, marine based survey 360 may tow each streamer in streamer array 374 at different depths such that seismic data may be acquired and processed in a manner that avoids the effects of destructive interference due to sea-surface ghost waves. For instance, marine-based survey 360 of FIG. 3B illustrates eight streamers towed by vessel 380 at eight different depths. The depth of each streamer may be controlled and maintained using the birds disposed on each streamer.

### Displaying Fully Connected Layers in a Neural Network as Seismic Data

The present disclosure unveils the internal mechanics of a neural network (NN). This may enhance interpretability, which can foster greater trust and accountability in artificial intelligence (AI) applications, reducing the risk of unwanted biases and errors. This may be accomplished by combining seismic data representations with techniques in neural network layer representation.

### Section of Seismic Data

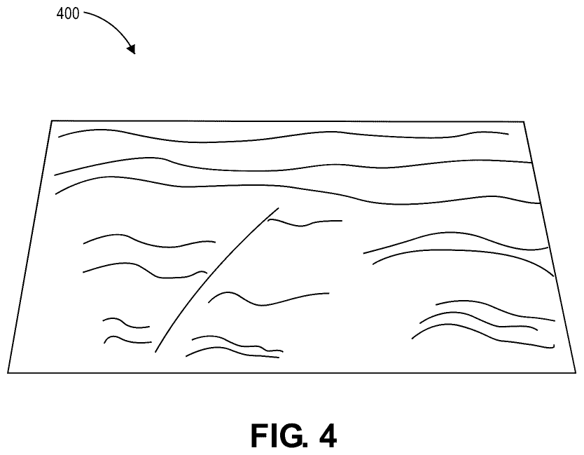

FIG. 4 illustrates a section (e.g., slice) 400 of seismic data (e.g., a seismic section) representing underground formations, according to an embodiment. The slice 400 may be a visual representation of a plurality of values (e.g., in a matrix). To some users, the slice 400 may provide a better visual understanding of the seismic data than the matrix. Using the same analogy, dense layers in a neural network can be represented in a matrix and seismic section accordingly.

### Neural Network

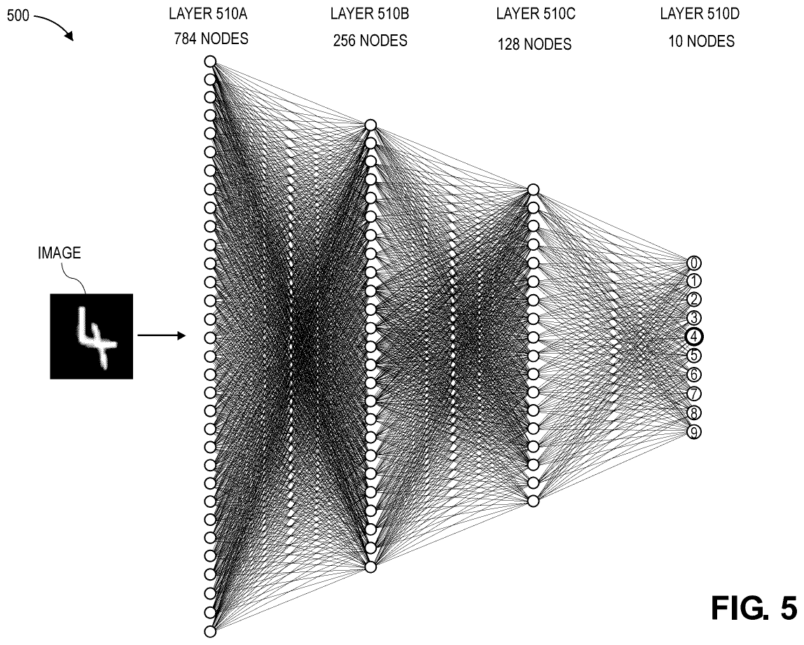

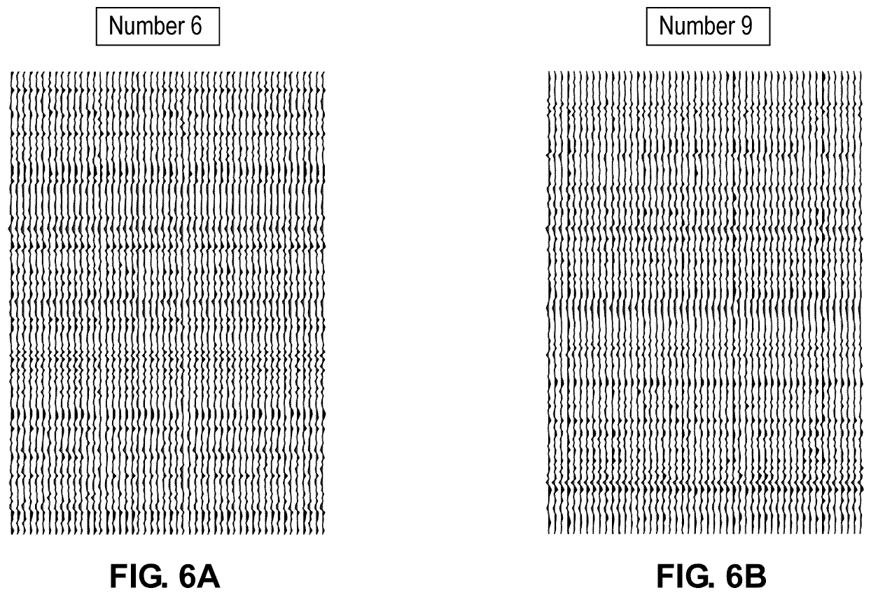

FIG. 5 illustrates a neural network 500 with one or more (e.g., two) hidden layers, according to an embodiment. Four layers are shown in the neural network. More particularly, a first layer 510A includes 784 nodes, a second layer 510B includes 256 nodes, a third layer 510C includes 128 nodes, and a fourth layer 510D includes 10 nodes. In an example, focusing on the layer 510C with 128 nodes, one input (e.g., image) may be associated with a long vector that can be presented by a signal trace. Instead of one image, if the user wants to see what that layer looks like for a plurality of (e.g., fifty) images, the same visualization technique that is used to process seismic data may be used.

### Hidden Layer

FIG. 6A and 6B illustrate representations of a hidden layer for a plurality of (e.g., fifty) different images, according to an embedment. In FIG. 6A, the fifty images are of the number 6, and in FIG. 6B, the fifty images are of the number 9. Each trace shows one image. Thus, in FIG. 6A, there are many number 6s. The system and method described herein may represent a large number of components in a neural network, so that a user can visually understand the impact of hyperparameters, and find out how the network does the learning process.

### Matrix and Trace

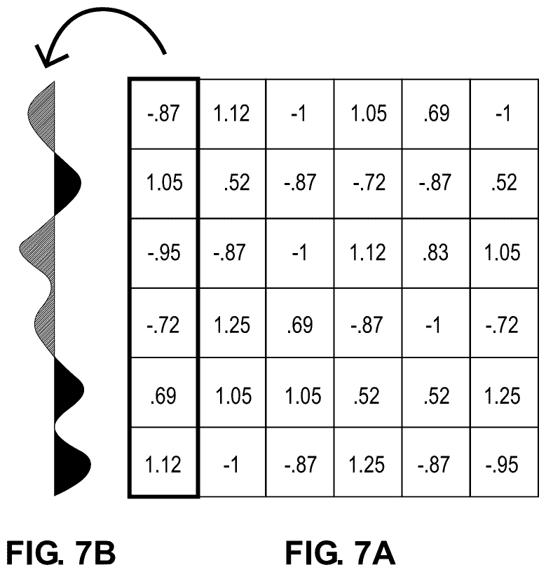

FIG. 7A illustrates a matrix, and FIG. 7B illustrates a trace that is a visual representation of a first column of the matrix, according to an embodiment. As will be appreciated, each column of the matrix may be visually represented by a different trace.

### Exemplary Method

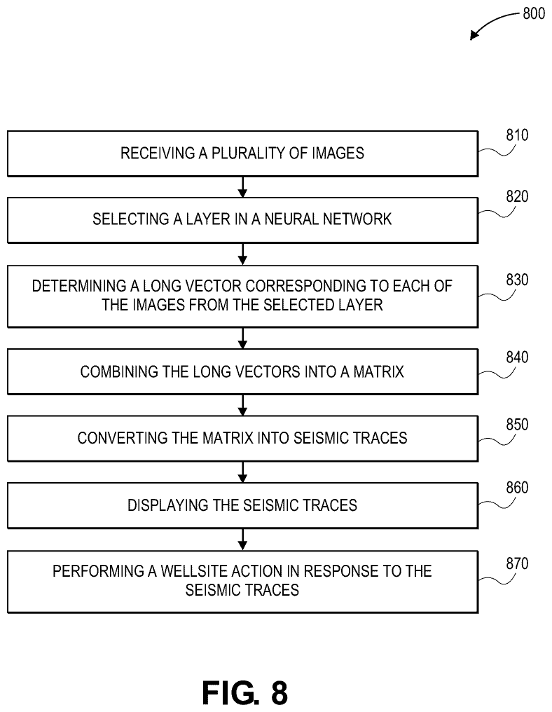

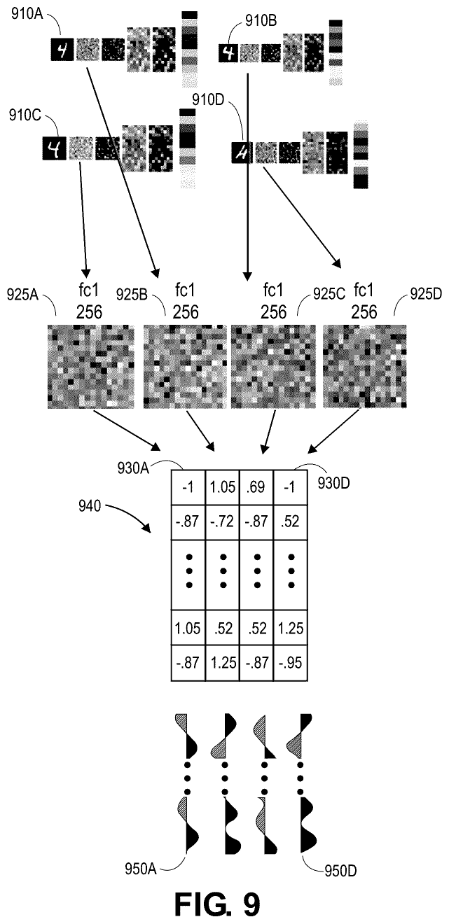

FIG. 8 illustrates a flowchart of a method 800 for improving an interpretability of the neural network 500, according to an embodiment. An illustrative order of the method 800 is provided below; however, one or more portions of the method 800 may be performed in a different order, simultaneously, repeated, or omitted. FIG. 9 illustrates a schematic view of the method 800, according to an embodiment.

The method 800 includes receiving a plurality of images, as at 810. Examples of the images are shown at 910A-910D in FIG. 9. The images 910A-910D may be or include core images of a subsurface formation. The images 910A-910D may be received by the neural network 500. As discussed above with reference to FIG. 5, the neural network 500 may include a plurality of layers (four are shown: 510A-510D).

The method 800 may also include selecting one of the layers 510A-510D in the neural network 500, as at 820. The selected layer (e.g., layer 510C) may have or include a predetermined number of nodes (e.g., 128 nodes), as shown in FIG. 5.

The method 800 may also include determining a long vector corresponding to each of the images 910A-910D, as at 830. The long vectors are shown at 930A-930D in FIG. 9. The long vectors 930A-930D may each be determined from or based upon the (same) selected layer 510C in the neural network 500. The long vectors 930A-930D may be determined by extracting neural responses 925A-925D to predetermined features in the images 910A-910D. The long vectors 930A-930D may capture the neural responses 925A-925D as a linear representation of the predetermined features. The predetermined features may be or include an edge, a color, a hole that is circular or planar, or a combination thereof.

The method 800 may also include combining the long vectors 930A-930D into a matrix, as at 840. The matrix is shown at 940 in FIG. 9. The matrix 940 may be or include a 2D or 3D matrix. The matrix 940 may include a plurality of columns, each including one of the long vectors 930A-930D. Each of the long vectors 930A-930D and/or columns may include or represent a unique set of the predetermined features.

The method 800 may also include converting each of the columns into a seismic trace, as at 850. One example of this is shown in FIGS. 7A and 7B. This may produce a plurality of seismic traces. Examples of the seismic traces are also shown at 950A-950D in FIG. 9. Each of the columns may be converted by mapping variations in an intensity of the predetermined features along a spatial dimension of the images 910A-910D. The intensity may be or include a value of a number in the long vectors 930A-930D and/or the matrix 940. An example of the intensity may be [1, −5, −1]. Each of the columns may be converted by transforming data from the long vectors 930A-930D into a data format analogous to seismic data. The seismic traces 950A-950D may reveal hidden patterns and/or relationships within the images 910A-910D, making the neural responses 925A-925D interpretable in a known geoscience context. In one example, the hidden patterns and/or relationships may be or include a shape in the images that is associated with a predetermined pattern or color (e.g., dark, light, etc.). In another example, a shape in the images 910A-910D may create the hidden patterns in the neural responses 925A-925D. In yet another example, as shown in FIGS. 6A and 6B, it may be seen that each number (e.g., 6 and 9) creates a certain pattern (i.e., the seismic images associated with these two numbers are different).

The method 800 may also include displaying the seismic traces 950A-950D, as at 860. In an embodiment, the seismic traces 950A-950D may be displayed collectively as a seismic section 400 (see FIG. 4). The seismic section 400 may be easier to interpret than the long vectors 930A-930D in the layers of the neural network 500.

The method 800 may also include performing a wellsite action in response to the seismic traces 950A-950D and/or the seismic section 400, as at 870. Performing the wellsite action may include generating or transmitting a signal that instructs or causes a physical action to occur at a wellsite. The physical action may be or include selecting where to drill a wellbore, drilling the wellbore, varying a weight and/or torque on a drill bit that is drilling the wellbore, varying a drilling trajectory of the wellbore, or varying a concentration and/or flow rate of a fluid pumped into the wellbore.

In general, AI is driven by open-source communities. Visualizing and interpreting the weights of neural networks is a breakthrough as it helps understand how these models make their decisions. There can be many commercial uses for this technology. In one example, this technology may be used in model explainability tools to develop a platform or tool that helps AI developers better understand their models. This can be a standalone product or as a part of a larger suite of AI development tools.

In another example, this technology may be used in education and training. Many people are interested in learning about AI, but the complexity of these models can be a barrier. A tool that visualizes and interprets neural networks can be used to create educational materials, online courses, or even entire training programs.

In another example, this technology may be used in AI auditing. As AI becomes more prevalent, so will AI auditing. This involves assessing an AI system's fairness, safety, and adherence to regulations. This technology can be used to provide transparency and help auditors understand how decisions are being made.

In another example, this technology may be used in predictive maintenance. AI models can predict when equipment is likely to fail or need maintenance. Understanding these models can help engineers better plan their maintenance schedules, improving efficiency and preventing costly shutdowns.

In another example, this technology may be used in environmental impact assessment. AI models can assess the environmental impact of various activities, like drilling or transporting oil. Visualizing and interpreting these models can help companies improve their environmental practices and comply with regulations. In each of these examples, the selling point is trust. By allowing users to interpret and understand their models, this technology can help build trust in AI systems, which can lead to wider adoption and more effective use of these methods.

### Exemplary Computing System

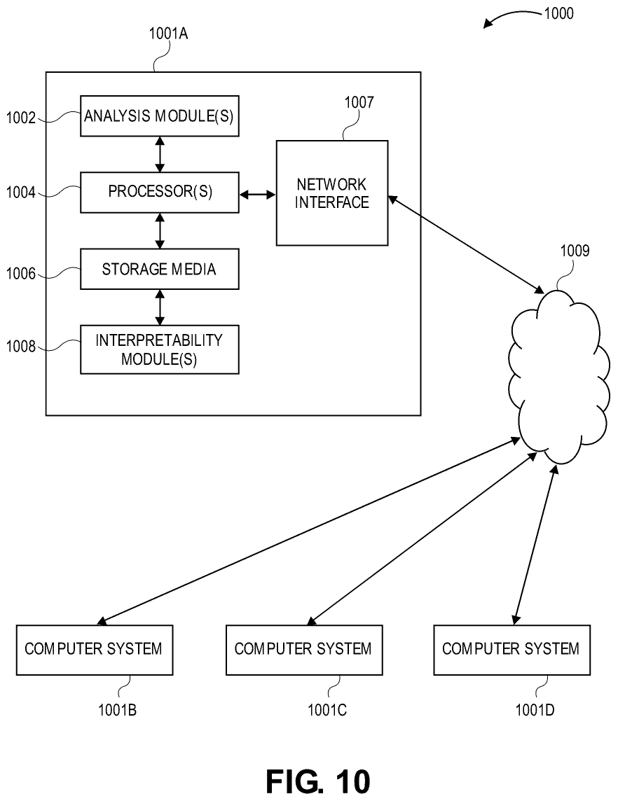

In some embodiments, the methods of the present disclosure may be executed by a computing system. FIG. 10 illustrates an example of such a computing system 1000, in accordance with some embodiments. The computing system 1000 may include a computer or computer system 1001A, which may be an individual computer system 1001A or an arrangement of distributed computer systems. The computer system 1001A includes one or more analysis modules 1002 that are configured to perform various tasks according to some embodiments, such as one or more methods disclosed herein. To perform these various tasks, the analysis module 1002 executes independently, or in coordination with, one or more processors 1004, which is (or are) connected to one or more storage media 1006. The processor(s) 1004 is (or are) also connected to a network interface 1007 to allow the computer system 1001A to communicate over a data network 1009 with one or more additional computer systems and/or computing systems, such as 1001B, 1001C, and/or 1001D (note that computer systems 1001B, 1001C and/or 1001D may or may not share the same architecture as computer system 1001A, and may be located in different physical locations, e.g., computer systems 1001A and 1001B may be located in a processing facility, while in communication with one or more computer systems such as 1001C and/or 1001D that are located in one or more data centers, and/or located in varying countries on different continents).

A processor may include a microprocessor, microcontroller, processor module or subsystem, programmable integrated circuit, programmable gate array, or another control or computing device.

The storage media 1006 may be implemented as one or more computer-readable or machine-readable storage media. Note that while in the example embodiment of FIG. 10 storage media 1006 is depicted as within computer system 1001A, in some embodiments, storage media 1006 may be distributed within and/or across multiple internal and/or external enclosures of computing system 1001A and/or additional computing systems. Storage media 1006 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above may be provided on one computer-readable or machine-readable storage medium, or may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

In some embodiments, computing system 1000 contains one or more interpretability module(s) 1008. In the example of computing system 1000, computer system 1001A includes the interpretability module 1008. In some embodiments, a single interpretability module 1008 may be used to perform some aspects of one or more embodiments of the methods disclosed herein. In other embodiments, a plurality of interpretability modules 1008 may be used to perform some aspects of methods herein.

It should be appreciated that computing system 1000 is merely one example of a computing system, and that computing system 1000 may have more or fewer components than shown, may combine additional components not depicted in the example embodiment of FIG. 10, and/or computing system 1000 may have a different configuration or arrangement of the components depicted in FIG. 10. The various components shown in FIG. 10 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAS, PLDs, or other appropriate devices. These modules, combinations of these modules, and/or their combination with general hardware are included within the scope of the present disclosure.

Computational interpretations, models, and/or other interpretation aids may be refined in an iterative fashion; this concept is applicable to the methods discussed herein. This may include use of feedback loops executed on an algorithmic basis, such as at a computing device (e.g., computing system 1000, FIG. 10), and/or through manual control by a user who may make determinations regarding whether a given step, action, template, model, or set of curves has become sufficiently accurate for the evaluation of the subsurface three-dimensional geologic formation under consideration.

The foregoing description, for purpose of explanation, has been described with reference to specific embodiments. However, the illustrative discussions above are not intended to be exhaustive or limiting to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principles of the disclosure and its practical applications, to thereby enable others skilled in the art to best utilize the disclosed embodiments and various embodiments with various modifications as are suited to the particular use contemplated.

What is claimed is:

1. A method for improving an interpretability of a neural network, the method comprising:
receiving a plurality of images, wherein the plurality of images are received by the neural network that comprises a plurality of layers;
selecting one of the layers from the plurality of layers in the neural network;
determining a long vector corresponding to each of the images of the plurality of images to produce a plurality of long vectors, wherein the plurality of long vectors are each determined from the selected layer;
combining the plurality of long vectors into a matrix; and
converting the matrix into a plurality of seismic traces.

2. The method of claim 1, wherein the plurality of images comprise core images of a subsurface formation.

3. The method of claim 1, wherein the selected layer comprises a predetermined number of nodes.

4. The method of claim 1, wherein the plurality of long vectors are determined by extracting neural responses to predetermined features in the plurality of images.

5. The method of claim 4, wherein the plurality of long vectors capture the neural responses as a linear representation of the predetermined features.

6. The method of claim 4, wherein the matrix is converted by mapping variations in an intensity of the predetermined features along a spatial dimension of the images, and wherein the intensity comprises a value of a number in the plurality of long vectors or the matrix.

7. The method of claim 4, wherein the seismic traces reveal hidden patterns or relationships within the images, making the neural responses interpretable in a known geoscience context.

8. The method of claim 1, wherein the matrix comprises a 2D matrix having a plurality of columns, and wherein each column of the plurality of columns is converted into one of the seismic traces.

9. The method of claim 1, further comprising displaying the seismic traces.

10. The method of claim 1, performing a wellsite action in response to the seismic traces.

11. A computing system, comprising:
one or more processors; and
a memory system comprising one or more non-transitory computer-readable media storing instructions that, when executed by at least one of the one or more processors, cause the computing system to perform operations, the operations comprising:
receiving a plurality of images, wherein the plurality of images comprise core images of a subsurface formation, wherein the plurality of images are received by a neural network that comprises a plurality of layers;
selecting one of the layers from the plurality of layers in the neural network, wherein the selected layer comprises a predetermined number of nodes;
determining a long vector corresponding to each of the plurality of images to produce a plurality of long vectors, wherein the plurality of long vectors are each determined from the selected layer, wherein the plurality of long vectors are determined by extracting neural responses to predetermined features in the images, and wherein the plurality of long vectors capture the neural responses as a linear representation of the predetermined features;
combining the plurality of long vectors into a matrix, wherein the matrix comprises a 2D matrix, and wherein the matrix comprises a plurality of columns;
converting each of the columns into a seismic trace to produce a plurality of seismic traces, wherein each of the columns is converted by mapping variations in an intensity of the predetermined features along a spatial dimension of the images, wherein the intensity comprises a value of a number in the long vectors or the matrix, and wherein the seismic traces reveal hidden patterns or relationships within the images, making the neural responses interpretable in a known geoscience context; and
displaying the seismic traces, wherein the seismic traces are displayed collectively as a seismic section.

12. The computing system of claim 11, wherein the predetermined features comprise an edge, a color, or a hole that is circular or planar.

13. The computing system of claim 11, wherein each of the columns comprises a unique set of the predetermined features.

14. The computing system of claim 11, wherein each of the columns is converted by transforming data from the long vectors into a data format analogous to seismic data.

15. The computing system of claim 11, wherein the hidden patterns and relationships comprise a shape in the images that is associated with a predetermined pattern or color.

16. A non-transitory computer-readable medium storing instructions that, when executed by one or more processors of a computing system, cause the computing system to perform operations, the operations comprising:
receiving a plurality of images, wherein the plurality of images comprise core images of a subsurface formation, wherein the plurality of images are received by a neural network that comprises a plurality of layers;
selecting one of the layers from the plurality of layers in the neural network, wherein the selected layer comprises a predetermined number of nodes;
determining a long vector corresponding to each of the images of the plurality of images to produce a plurality of long vectors, wherein the plurality of long vectors are each determined from the selected layer, wherein the plurality of long vectors are determined by extracting neural responses to predetermined features in the plurality of images, wherein the plurality of long vectors capture the neural responses as a linear representation of the predetermined features, and wherein the predetermined features comprise an edge, a color, or a hole that is circular or planar;
combining the plurality of long vectors into a matrix, wherein the matrix comprises a 2D matrix, wherein the matrix comprises a plurality of columns, and wherein each column of the plurality of columns comprises a unique set of the predetermined features;
converting each column of the plurality of columns into a seismic trace to produce a plurality of seismic traces, wherein each column of the plurality of columns is converted by mapping variations in an intensity of the predetermined features along a spatial dimension of the plurality of images, wherein the intensity comprises a value of a number in the long vector or the matrix, wherein each column of the plurality of columns is converted by transforming data from the plurality of long vectors into a data format analogous to seismic data, wherein the seismic traces reveal hidden patterns or relationships within the plurality of images, making the neural responses interpretable in a known geoscience context, wherein the hidden patterns and relationships comprise a shape in the plurality of images that is associated with a predetermined pattern or color; and
displaying the seismic traces, wherein the seismic traces are displayed collectively as a seismic section.

17. The non-transitory computer-readable medium of claim 16, wherein the seismic section is easier to interpret than the plurality of long vectors in the layers of the neural network.

18. The non-transitory computer-readable medium of claim 16, wherein the operations further comprise performing a wellsite action in response to the seismic traces.

19. The non-transitory computer-readable medium of claim 18, wherein performing the wellsite action comprises generating or transmitting a signal that instructs or causes a physical action to occur at a wellsite.

20. The non-transitory computer-readable medium of claim 19, wherein the physical action comprises selecting where to drill a wellbore, drilling the wellbore, varying a weight and/or torque on a drill bit that is drilling the wellbore, varying a drilling trajectory of the wellbore, or varying a concentration and/or flow rate of a fluid pumped into the wellbore.
